(19) United States
(12) Patent Application Publication
(10) Pub. No.: US 2026/0110183 A1
(43) Pub. Date: Apr. 23, 2026

(54) SPACERS, WALLS, AND METHODS OF CONSTRUCTING A WALL

(71) Applicant: DeYaga, LLC, Park City, UT (US)

(72) Inventor: Willem Jacobus de Jager, Park City, UT (US)

(21) Appl. No.: 19/366,189

(22) Filed: Oct. 22, 2025

Related U.S. Application Data
(60) Provisional application No. 63/710,724, filed on Oct. 23, 2024.

(51) Int. Cl. E04G 21/18; F16M 13/02

(52) U.S. Cl. CPC E04G 21/1883; F16M 13/02

(57) ABSTRACT

A wall spacer includes a frame and a clamping structure extending from the frame. The clamping structure is configured to secure one or more utilities to the frame. The wall spacer further includes a primary gap defined in a first end of the frame. The primary gap is configured to receive a first structural component. The wall spacer also includes a secondary gap defined in a second end of the frame opposite the first end of the frame. The secondary gap is configured to receive a second structural component.

### CROSS-REFERENCE TO RELATED APPLICATION

This application claims the benefit under 35 U.S.C. § 119(e) of U.S. Provisional Patent Application Serial No. 63/710,724, filed October 23, 2024, the disclosure of which is hereby incorporated herein in its entirety by this reference.

### TECHNICAL FIELD

Embodiments of the present disclosure generally relate to spacers. In particular, embodiments of the present disclosure relate to spacer brackets, structural spacers, and methods of constructing a structure including spacers.

### BACKGROUND

Structures such as houses and commercial buildings include multiple walls defining the space within the associated structure. The walls are constructed with an outer surface and an inner surface spaced apart by a framework, such as a wooden frame or metal frame formed from studs (e.g., wooden studs or metal studs). The space between the outer surface and the inner surface provides a space for running utilities, such as water lines, drain lines, electrical wires, etc. The space between the outer surface and the inner surface may also provide insulation, at least due to the air gap between the inner surface and the outer surface and in some cases additional insulation may be added to the space between the inner surface and the outer surface of the wall.

Insulating the inner surface from the outer surface may reduce heat loss and/or heat gain through the wall when the temperature difference on the two sides of the wall is significant, such as an exterior wall positioned between a conditioned space and the outside environment. Reducing heat loss and/or heat gain may increase an efficiency of the associated structure, such as by reducing the energy used to condition the interior space.

### BRIEF SUMMARY

Some embodiments of the disclosure include a wall spacer. The wall spacer includes a frame and a clamping structure extending from the frame. The clamping structure is configured to secure one or more utilities to the frame. The wall spacer further includes a primary gap defined in a first end of the frame. The primary gap is configured to receive a first structural component. The wall spacer also includes a secondary gap defined in a second end of the frame opposite the first end of the frame. The secondary gap is configured to receive a second structural component.

Another embodiment of the disclosure includes a wall. The wall includes a framework formed from one or more studs. The wall further includes an alignment structure. The wall also includes one or more spacers positioned between the framework and the alignment structure. At least one of the one or more studs are disposed in a primary gap of the one or more spacers and the alignment structure is disposed in a secondary gap of the one or more spacers, where the primary gap and the secondary gap are on opposing sides of the one or more spacers.

Other embodiments of the disclosure include a method of constructing a wall. The method includes forming a framework from studs. The method further includes disposing at least one stud of the studs into a primary gap defined by a spacer. The method also includes disposing an alignment structure into a secondary gap defined by the spacer on an opposite side of the spacer from the framework.

### BRIEF DESCRIPTION OF THE DRAWINGS

While the specification concludes with claims particularly pointing out and distinctly claiming embodiments of the present disclosure, the advantages of embodiments of the disclosure may be more readily ascertained from the following description of embodiments of the disclosure when read in conjunction with the accompanying drawings in which:

FIG. 1 illustrates a schematic cross-section of a wall in accordance with embodiments of the disclosure;

FIG. 2 illustrates a perspective view of a spacer in accordance with embodiments of the disclosure;

FIG. 3 illustrates a top-down view of an assembly of the spacers of FIG. 2 in accordance with embodiments of the disclosure;

FIG. 4 illustrates a perspective view of a wall including the assembly of FIG. 3 in accordance with embodiments of the disclosure;

FIG. 5 illustrates a top-down view of a portion of a structure including a wall of FIG. 4 in accordance with embodiments of the disclosure;

FIG. 6 illustrates a perspective view of a spacer in accordance with embodiments of the disclosure;

FIG. 7 illustrates a top-down view of a portion of a wall including the spacer of FIG. 6 in accordance with embodiments of the disclosure;

FIGS. 8-10 illustrate a spacer in accordance with embodiments of the disclosure;

FIGS. 11 and 12 illustrate portions of a wall including one or more of the spacers of FIGS. 8-10 in accordance with embodiments of the disclosure;

FIGS. 13 and 14 illustrate a space in accordance with embodiments of the disclosure; and

FIG. 15 illustrates a portion of a wall framework including one or more of the spacers of FIGS. 13 and 14 in accordance with embodiments of the disclosure.

### DETAILED DESCRIPTION

The following description provides specific details, such as material compositions, shapes, and sizes, in order to provide a thorough description of embodiments of the disclosure. However, a person of ordinary skill in the art would understand that the embodiments of the disclosure may be practiced without employing these specific details. Indeed, the embodiments of the disclosure may be practiced in conjunction with conventional techniques employed in the industry.

Drawings presented herein are for illustrative purposes only and are not meant to be actual views of any particular material, component, structure, device, or system. Variations from the shapes depicted in the drawings as a result, for example, of manufacturing techniques and/or tolerances, are to be expected. Thus, embodiments described herein are not to be construed as being limited to the particular shapes or regions as illustrated, but include deviations in shapes that result, for example, from manufacturing. For example, a region illustrated or described as box-shaped may have rough and/or nonlinear features, and a region illustrated or described as round may include some rough and/or linear features. Moreover, sharp angles that are illustrated may be rounded, and vice versa. Thus, the regions illustrated in the figures are schematic in nature, and their shapes are not intended to illustrate the precise shape of a region and do not limit the scope of the present claims. The drawings are not necessarily to scale. Additionally, elements common between figures may retain the same numerical designation.

As used herein, the term “substantially” in reference to a given parameter means and includes to a degree that one skilled in the art would understand that the given parameter, property, or condition is met with a small degree of variance, such as within acceptable manufacturing tolerances. By way of example, depending on the particular parameter, property, or condition that is substantially met, the parameter, property, or condition may be at least 90.0 percent met, at least 95.0 percent met, at least 99.0 percent met, at least 99.9 percent met, or even 100.0 percent met.

As used herein, “about” in reference to a numerical value for a particular parameter is inclusive of the numerical value and a degree of variance from the numerical value that one of ordinary skill in the art would understand is within acceptable tolerances for the particular parameter. For example, “about” in reference to a numerical value may include additional numerical values within a range of from 90.0 percent to 110.0 percent of the numerical value, such as within a range of from 95.0 percent to 105.0 percent of the numerical value, within a range of from 97.5 percent to 102.5 percent of the numerical value, within a range of from 99.0 percent to 101.0 percent of the numerical value, within a range of from 99.5 percent to 100.5 percent of the numerical value, or within a range of from 99.9 percent to 100.1 percent of the numerical value.

As used herein, relational terms, such as “below,” “lower,” “bottom,” “above,” “upper,” “top,” and the like, may be used for ease of description to describe one element’s or feature’s relationship to another element(s) or feature(s) as illustrated in the drawings. Unless otherwise specified, the spatially relative terms are intended to encompass different orientations of the materials in addition to the orientation depicted in the figures. For example, if materials in the figures are inverted, elements described as “below” or “under” or “on bottom of” other elements or features would then be oriented “above” or “on top of” the other elements or features. Thus, the term “below” can encompass both an orientation of above and below, depending on the context in which the term is used, which will be evident to one of ordinary skill in the art. The materials may be otherwise oriented (e.g., rotated 90 degrees, inverted, flipped) and the spatially relative descriptors used herein interpreted accordingly.

As used herein, the terms “vertical,” “longitudinal,” “horizontal,” and “lateral” are in reference to a major plane of a structure and are not necessarily defined by earth’s gravitational field. A “horizontal” or “lateral” direction is a direction that is substantially parallel to the major plane of the structure, while a “vertical” or “longitudinal” direction is a direction that is substantially perpendicular to the major plane of the structure. The major plane of the structure is defined by a surface of the structure having a relatively large area compared to other surfaces of the structure. With reference to the drawings, a “horizontal” or “lateral” direction may be perpendicular to an indicated “Z” axis, and may be parallel to an indicated “X” axis and/or parallel to an indicated “Y” axis; and a “vertical” or “longitudinal” direction may be parallel to an indicated “Z” axis, may be perpendicular to an indicated “X” axis, and may be perpendicular to an indicated “Y” axis.

As used herein, the singular forms “a,” “an,” and “the” are intended to include the plural forms as well, unless the context clearly indicates otherwise.

As used herein, the term “and/or” means and includes any and all combinations of one or more of the associated listed items.

As discussed above, walls of a structure are constructed with an outer surface and an inner surface separated by a framework to form an open space between the inner surface and the outer surface. In conventional construction, the wall is built through multiple different processes by separate contractors. For example, the framework may be built first followed utilities being run within the framework. In some embodiments, the structures forming the outer surface and the inner surface may be installed at different times. For example, one of the inner structure or the outer structure may be installed before the utilities are run within the framework and the other may be installed after the utilities are run through the framework.

Constructing a wall in this manner may result in inconsistencies in the construction. In some cases, the inconsistencies may result in damage or fitment issues. For example, inconsistent placement of utilities within the framework may result in damage to the utilities during the later installation of other structures, such as the inner structure or the outer structure. Other inconsistencies, such as inconsistent spacing of frame components (e.g., studs) may cause fitment issues with one or more of the inner structure, the outer structure, and/or the utilities run within the framework. Furthermore, the reliance on multiple different contractors may result in delays to other phases of construction.

Embodiments of the disclosure may result in walls having greater consistency and predictability in construction. The walls of a structure support the structure and provide a mounting place for the bulk of the utilities of the structure. Therefore, increasing the consistency and predictability of a wall in construction may significantly reduce the costs of construction. Embodiments of the disclosure may also increase the insulation factors (e.g., R values) of a wall, which may result in structures that are more efficient for heating and/or cooling the conditioned space within the structure.

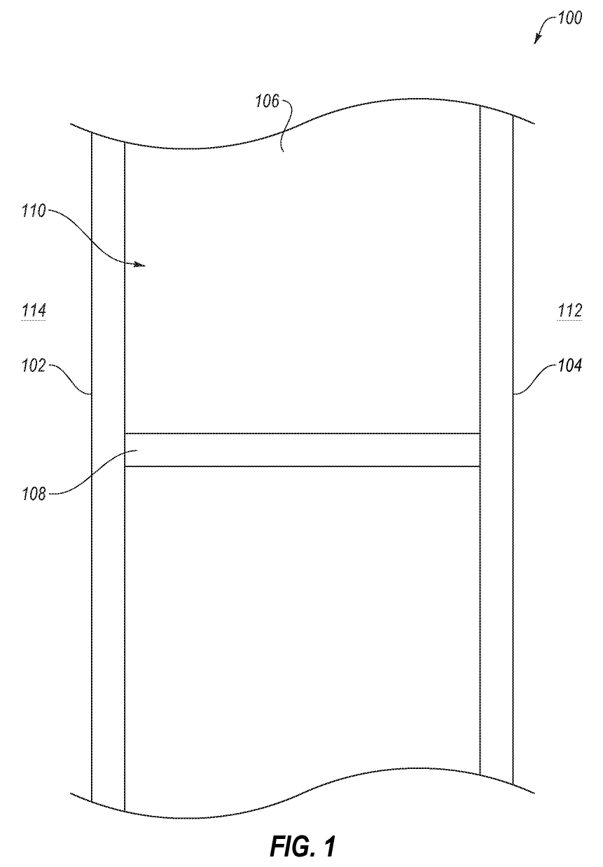

FIG. 1 illustrates a simplified cross-section of a wall 100. The wall 100 includes an outer structure 102 and an inner structure 104 separated by a stud 106. The stud 106 may be part of a larger framework within the wall 100. In some embodiments, the stud 106 is formed from wood (e.g., lumber). For example, the stud 106 may be a wooden 2x4, 2x6, or other standard lumber size used for forming the framework within a wall. In another embodiment, the stud 106 is formed from metal, such as steel or aluminum. For example, the stud 106 may be stamped or rolled out of sheet metal into a rectangular shape configured to provide structural support to the wall 100.

The wall 100 also includes a spacer 108 positioned between the outer structure 102 and the inner structure 104. The spacer 108 may be formed from a rigid material, such as a metal material or a rigid polymer (e.g., polyvinylchloride (PVC), polypropylene, polystyrene, etc.). The spacer 108 may be configured to maintain a gap 110 between the outer structure 102 and the inner structure 104 and/or a spacing between adjacent studs 106 in the framework. In some embodiments, as discussed in further detail below, the spacers 108 include structures configured to receive and secure utilities mounted within the gap 110 between the outer structure 102 and the inner structure 104.

The wall 100 is positioned between an interior space 112 and an exterior space 114, where the inner structure 104 is on the side of the wall 100 facing the interior space 112, and the inner structure 104 is on the side of the wall 100 facing the exterior space 114. In some embodiments, the interior space 112 and the exterior space 114 are each conditioned spaces, such as where the wall 100 is an interior wall between two spaces in a common structure. In other embodiments, the interior space 112 may be a conditioned space and the exterior space 114 may be an unconditioned space, such as an outdoor space or an unconditioned room, such as a garage.

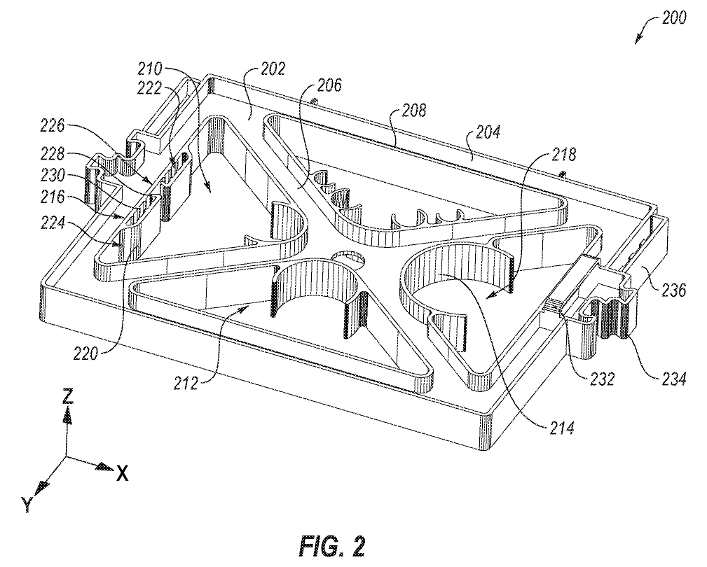

FIG. 2 illustrates an embodiment of a spacer 200 that may be positioned in the space between two structures of a wall, such as the spacer 108 of FIG. 1. The spacer 200 includes a frame 202 formed from outer structures 204 and struts 206. The frame 202 may exhibit a substantially rectangular shape defined by the outer structures 204. In other embodiments, the frame 202 may exhibit a substantially triangular, circular, trapezoidal, planar, L-shape, etc., or a combination of any of the foregoing shapes. The spacer 200 includes sidewalls 208 of the outer structures 204 and the struts 206 that define one or more openings 210 in the frame 202 of the spacer 200.

The spacer 200 may include a plurality of clamping structures 212. The clamping structures 212 may be configured to receive utilities such as water supply lines, water drainpipes, sewage drainpipes, electrical wiring, conduits, etc., therein and secure them relative to the frame 202 of the spacer 200. At least some of the clamping structures 212 may be configured to secure the utilities in a direction substantially perpendicular to a plane of the frame 202 (e.g., where the utilities run in the Z-direction). The clamping structures 212 may include circular clamps 214 and elongated clamps 216. The circular clamps 214 exhibit a substantially circular shape. The circular clamp 214 may include an opening 218 configured to facilitate receiving a utility structure. The inner diameter of the circular clamp 214 may be complementary to the outer diameter of a utility to be secured within the circular clamp 214. For example, the inner diameter of the circular clamp 214 may be about the same or slightly smaller than the outer diameter of a utility having a substantially circular shape, such as water lines, drain lines, electrical conduit. In some embodiments, the circular clamps 214 have diameters in a range from about ¼ inch to about 4 inches.

The spacer 200 may include multiple circular clamps 214. For example, in the embodiment illustrated in FIG. 2, the spacer 200 includes multiple circular clamps 214 extending from the frame 202 of the spacer 200 in different locations. The circular clamps 214 may have various diameters to accommodate multiple different utilities within the same spacer 200. For example, the embodiment illustrated in FIG. 2 includes a large circular clamp 214 with a large diameter (e.g., in a range from about 1 in to about 4 in, such as about 2 in), two medium circular clamps 214 with medium diameters (e.g., in a range from about ½ in to about 2 in), and four smaller circular clamps 214 having a small diameter (e.g., in a range from about ¼ in to about 1 in).

The spacer 200 also includes elongated clamps 216 extending from the frame 202. The elongated clamp 216 may include an arm 220 defining an elongated opening 222 in the elongated clamp 216. The arm 220 may be connected to a sidewall 208 of the frame 202 at a first end 224 of the elongated clamp 216 and may float (e.g., not be connected to the sidewall 208) at a second end 226 of the elongated clamp 216. The arm 220 may be positioned at substantially a same distance from the sidewall 208 of the frame 202 in the associated region, such that a substantially constant gap is formed between the arm 220 and the sidewall 208. Thus, the elongated opening 222 may have a substantially constant dimension between the sidewall 208 and the arm 220 along the elongated clamp 216.

In some embodiments, the arm 220 is flexible such that the second end 226 may be displaced relative to the sidewall to facilitate receiving utilities within the elongated clamp 216. The second end 226 of the arm 220 may include a catch 228 configured to retain utilities within the elongated clamp 216. The catch 228 may extend substantially toward the sidewall 208 from the arm 220 and may curve toward the first end 224 of the elongated clamp 216. Thus, the catch 228 is configured to facilitate receiving a utility, such as electrical wires (e.g., single wires, bundled wires, shielded cables, sheathed cables, multi-conductor cables, etc.) through a taper formed between the catch 228 and the sidewall 208 at the floating second end 226 of the arm 220 and retaining the utility within the elongated clamp 216.

The elongated clamp 216 may also include a plurality of ridges 230 or teeth. The ridges may be located on the sidewall 208 and the arm 220 directed into the elongated opening 222 of the elongated clamp 216. The ridges 230 may facilitate securing multiple utilities within the elongated clamp 216. For example, the ridges 230 may be configured to extend at least partially between two or more wires or cables within the elongated opening 222 of the elongated clamp 216 to separate the wires or cables. The ridges may substantially prevent the wires from moving within the elongated clamp 216 or getting tangled with other wires within the elongated clamp 216.

The spacer 200 may also include at least one lateral clamp 232. The lateral clamp 232 may facilitate securing a utility to the spacer 200 in a direction substantially parallel to the frame 202 (e.g., in the X-direction). For example, the lateral clamp 232 may facilitate capturing utilities extending in a direction perpendicular to the utilities captured by the circular clamps 214 and the elongated clamps 216. In some embodiments, the lateral clamp 232 facilitates utilities that are already captured in one of the circular clamps 214 and the elongated clamps 216 to change direction within the associated wall. In some embodiments, the lateral clamp 232 is sized and shaped similar to the elongated clamp 216. In other embodiments, the lateral clamp 232 may be larger to facilitate the capture of larger utilities, a greater number of utilities, or a wider variety of utilities.

The spacer 200 may include at least one connector 234. The connector 234 may facilitate connection between two spacers 200. The connector 234 may be unitarily formed into one or more of the outer structures 204 of the frame 202. The connector 234 of a spacer 200 may be configured to connect with the connector 234 of an adjacent spacer 200 through mechanical interference. For example, the connectors 234 may have complementary shapes similar to a jigsaw piece connection. In some embodiments, the connector 234 may include other types of connections, such as threads, welds, bolts, snap-fits, pins, adhesives, rivets, etc.

The spacer 200 may include at least one removable portion 236. The removable portion 236 may be located on the same side of the spacer 200 as the connector 234. The removable portion 236 may be connected to the sidewall 208 such that it can be broken off of the spacer 200 without damaging or lowering the integrity of the frame 202 or sidewall 208. For example, the removable portion 236 may be configured to facilitate different configurations. For example, with the removable portion 236 present, the spacer 200 may be installed in a wall having a first configuration, such as with a frame having a first configuration (e.g., studs formed from a first type of material or having a first set of dimensions) or inner and outer structures (e.g., outer structure 102, inner structure 104 (FIG. 1)) having a first configuration. In another example, with the removable portion 236 removed, the spacer 200 may be installed in a wall having a second configuration, such as with a frame having a second configuration (e.g., studs formed from a second different type of material or having a second different set of dimensions) or inner and outer structures (e.g., outer structure 102, inner structure 104 (FIG. 1)) having a second configuration. Thus, the removable portions 236 may facilitate using the same spacer 200 in multiple different types of walls or walls that are constructed differently.

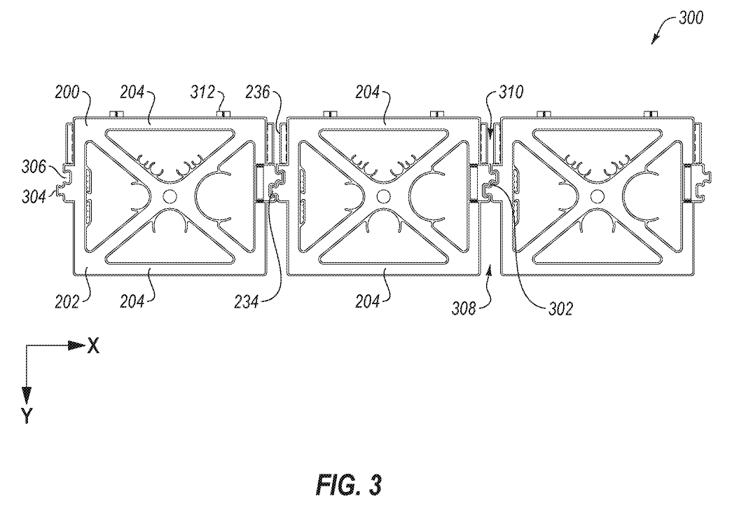

FIG. 3 illustrates a spacer assembly 300 including multiple spacers 200 connected together through the connectors 234. The spacers 200 may each be arranged in substantially the same plane (e.g., the X-Y plane). In other examples, the connection between two spacers 200 may form an angle such that the two spacers 200 extend in different planes. For example, the connection between spacers 200 may form about a 90 degree angle such that a first spacer 200 extends in the X-Y plane and a second spacer 200 extends in the X-Z plane.

As discussed above, the connectors 234 of two adjacent spacers 200 may have complementary geometry. As illustrated in FIG. 3, the connectors 234 have interlocking features. The interlocking features may include a protrusion 304 and a recess 306. In the embodiment illustrated in FIG. 3, the protrusion 304 and the recess 306 of each connector 234 are complementary, such that the protrusion 304 of a connector 234 of a spacer 200 is complementary with the recess 306 of a connector 234 in an adjacent spacer 200. The protrusion 304 and the recess 306 may be configured to interlock through mechanical interference. The interlocking features 302 of the connectors 234 may facilitate connecting the spacers 200 in a uniform manner, providing substantially constant gaps 308, 310 between the spacers 200 and maintaining the spacers 200 in an aligned arrangement, such that the outer structures 204 of the frames 202 of the adjacent spacers 200 are substantially aligned.

The spacer assembly 300 may define two gaps 308, 310 between adjacent spacers 200. The gaps may include a primary gap 308 and a secondary gap 310. The primary gaps 308 may be larger than the secondary gaps 310. For example, the primary gap 308 may be configured to secure the spacer assembly 300 relative to a framework (e.g., studs 106 (FIG. 1) that combine to form the framework) and the secondary gap 310 may be configured to receive locating structures, such as structure configured to maintain an arrangement between a wall structure (e.g., the inner structure 104 or the outer structure 102 (FIG. 1)) relative to the spacers 200 and the framework. In some embodiments, the removable portion 236 is removed such that the secondary gap 310 has substantially a same size as the primary gap 308. If the secondary gap 310 has substantially a same size as the primary gap 308, the secondary gap 310 may be configured to receive a secondary framework similar to the primary gap 308.

In conventionally constructed walls, the space between wall structures (e.g., gap 110 (FIG. 1)) may be substantially the same as a width of the framework. As illustrated in FIG. 3, the spacer assembly 300 may facilitate constructing walls with a greater space between the wall structures. Increasing the space between the wall structures may increase the insulative properties of the wall, at least by increasing the air gap between the wall structures and/or by increasing an area for additional insulative materials to be placed between the wall structures.

Each spacer 200 may include one or more pins 312. The pins 312 may be located on an edge of the frame 202 adjacent to the connectors 234. The pins 312 may extend substantially perpendicularly away from the sidewall 208 (e.g., in the Y-direction). The pins 312 may be configured to extend at least partially into a portion of an associated structure (e.g., outer structure 102, inner structure 104 (FIG. 1), etc.) secured to the spacer assembly 300. The pins 312 may be locating pins configured to facilitate fixing the spacer 200 relative to the associated structure.

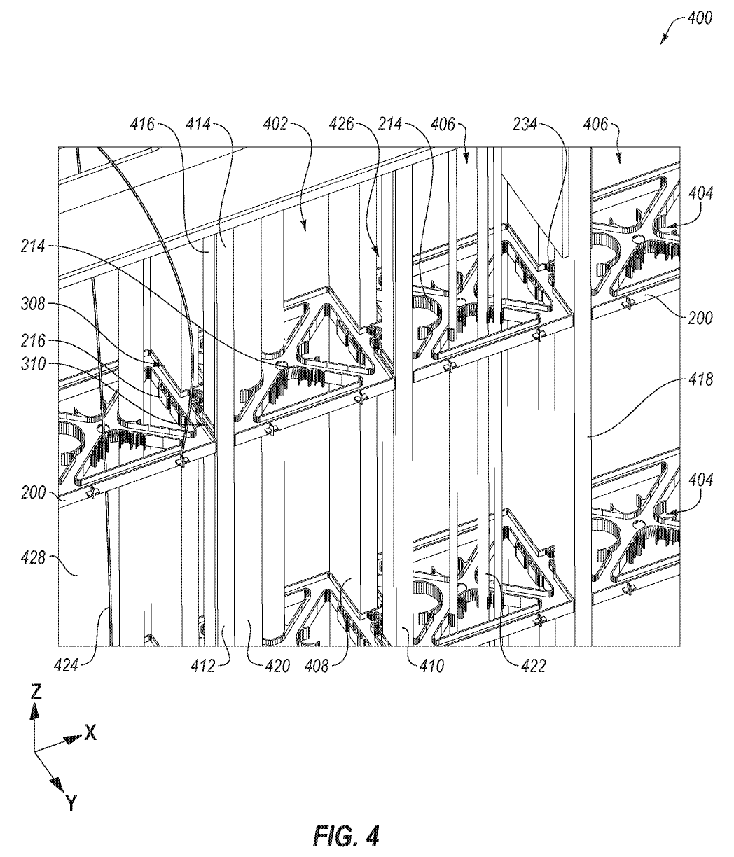

FIG. 4 illustrates a wall 400 with some of the wall structures removed to show the internal portions of the wall 400. The wall 400 may include one or more spacer assemblies 300 disposed within a cavity 402 of a wall 400. The wall 400 may include multiple rows 404 and columns 406 of the spacers 200 arranged within the cavity 402 of the wall 400. The spacers 200 in the wall 400 that are in a same row 404 are substantially aligned in the X-direction. The spacers 200 in the wall 400 that are in a same column 406 are substantially aligned in the Z-direction. The wall 400 may be a side wall of a structure, ceiling of the structure, a floor of the structure, or another structural part of the structure.

The wall 400 includes a plurality of studs 408. The studs 408 may be a conventional type of stud used in construction such as wooden studs or metal studs. For example, the wooden studs may be a 2x4, 2x6, a 4x4, etc. Examples of metal studs may include hot rolled steel and cold formed steel, stamped steel, etc. The studs 408 may be positioned in the primary gap 308 between two adjacent spacers 200. In some embodiments, the spacers 200 are secured to the studs 408, such as with hardware (e.g., nails, staples, screws, etc.) or through interfacing elements extending from the spacers 200, such as locator pins, clips, clamps, etc. In some embodiments, the spacers 200 provide additional support to the studs 408, such as functioning as bridges (e.g., nogging or blocking) between two studs 408 increasing resistance of the adjacent studs 408 to bending.

The spacer assembly 300 may be configured to receive one or more types of alignment structures 410 within the secondary gap 310 on an opposite side of the spacer assembly 300 from the primary gap 308. For example, the spacer assembly 300 may be configured to receive a “T” shaped alignment structure 412 in the secondary gap 310. The “T” shaped alignment structure 412 may be constructed from material that is narrower than the studs 408 positioned in the primary gap 308. For example, the “T” shaped alignment structure 412 may be formed from plywood, drywall, metal plate, etc. The “T” shaped alignment structures 412 include a flange 414 and a web 416. The web 416 may be configured to fit between the removable portions 236 of two adjacent spacers 200. Forming the “T” shaped alignment structure 412 from plywood, drywall, or metal plate may facilitate greater control over the shape of the “T” shaped alignment structure 412. For example, the “T” shaped alignment structure 412 may be less prone to warping than a conventional wooden stud. Furthermore, forming the “T” shaped alignment structures 412 may reduce waste produced during the construction of the wall 400. The “T” shaped alignment structures 412 may form the structure or framework for the associated wall structures (e.g., an inner structure (not shown) of the wall 400).

As discussed above, the removable portions 236 of two adjacent spacers 200 may be removed to facilitate larger structures being disposed in the secondary gap 310. For example, removing the removable portions 236 may facilitate two alignment structures 410 being received within the secondary gap 310. In the embodiment illustrated in FIG. 4, the removable portions 236 are removed from two of the spacers 200, such that a secondary stud 418 having similar dimensions to the studs 408 is disposed in the secondary gap 310.

In the embodiment illustrated in FIG. 4, the connectors 234 between adjacent spacers 200 in each row 404 are positioned between the studs 408 and the alignment structures 410 or secondary studs 418. Thus, the connectors 234 form a gap 426 between the studs 408 and the alignment structures 410 or the secondary studs 418. The gap 426 may facilitate passing utilities laterally through the wall 400 (e.g., in the X-direction), without reducing a strength of the framework of the wall 400. For example, the utilities may pass laterally through the wall 400 without removing material from any of the studs 408, alignment structures 410, or secondary studs 418.

The gap 426 may also increase a distance between an outer structure 428 of the wall 400 and an inner structure (not shown) of the wall. In other words, the gap 426 may increase a width of the cavity 402 between the outer structure 428 and the inner structure of the wall 400. Increasing the distance between the outer structure 428 and the inner structure of the wall 400 may increase the insulative properties of the wall 400 by increasing an air gap between the two sides of the wall 400. The increased distance between the outer structure 428 and the inner structure of the wall 400 may also create additional space for insulation to be placed in the cavity 402 to further increase the insulative properties of the wall 400. For example, the wall 400 may have an insulative rating in a range from about R-30 to about R-50, such as from about R-40 to about R-42.

As illustrated in FIG. 4, different utilities may be connected to the spacers 200 in different locations. For example, in the embodiment illustrated in FIG. 4, one column 406 of spacers includes water lines 422 connected to the spacers 200 through the smaller circular clamps 214, another column 406 of spacers 200 includes pipes 420 connected to the spacers 200 through the larger circular clamps 214, and yet another column 406 of spacers 200 includes wires 424 connected to the spacers 200 through the elongated clamps 216. In some embodiments, multiple different utilities may be connected to spacers in a same column 406. For example, pipes 420 may be connected to larger circular clamps 214 in a same column of spacers 200 as the water lines 422 that are connected to the smaller circular clamps 214. In the embodiment illustrated in FIG. 4, one of the columns 406 includes a pipe 420 connected to the spacers 200 through one of the circular clamps 214 in each spacer 200 in the column 406 and the wires 424 connected to the same spacers 200 in the column 406 through the elongated clamps 216.

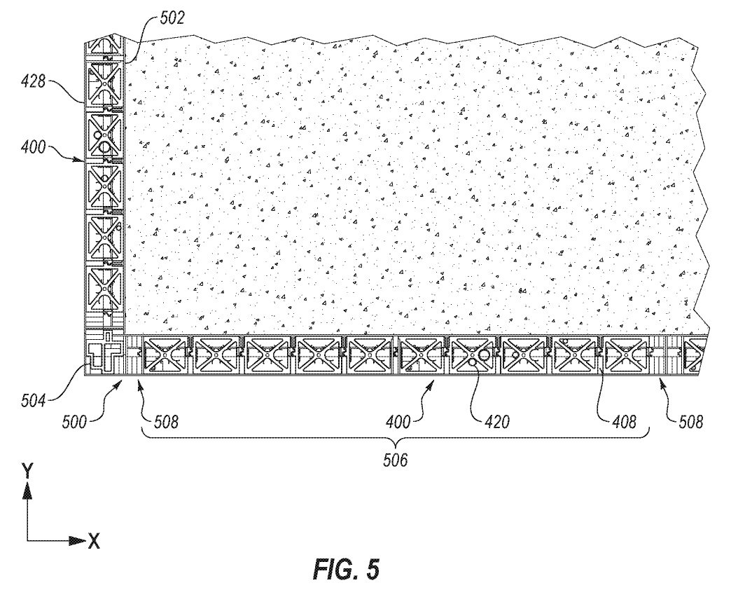

FIG. 5 illustrates a portion of a structure 500 formed from multiple walls 400. As discussed above, the wall 400 includes multiple spacers 200 aligned in rows 404. The spacers 200 are positioned within the framework of the wall 400 receiving studs 408, alignment structures 410, and secondary studs 418 of the wall 400. The wall 400 also includes outer structures 428 and inner structures 502 that form the planes of the walls. For example, the outer structure 428 and/or inner structure 502 may be formed from sheeting materials, such as wood sheet (e.g., plywood, chip board, wood paneling, etc.), drywall, plasterboard, cement sheet, etc. In some embodiments, the outer structure 428 and the inner structure 502 are formed from different materials. In other embodiments, the outer structure 428 and the inner structure 502 may be formed from the same material. The outer structures 428 and the inner structures 502 of the walls 400 may be secured to one or more of the studs 408, alignment structures 410, and secondary studs 418 of the wall 400.

The walls 400 may be formed in segments 506. The segments may include a number of spacers 200 in a row 404 positioned between two termination structures 508. The termination structures 508 may define ends of the segments 506. The termination structure 508 may be formed from multiple studs 408 stacked together to form the termination structure 508. In other embodiments, the termination structure 508 may be formed from a larger structure, such as a larger wooden structure (e.g., having larger dimensions than the studs 408) or a larger metal structure (e.g., having larger dimensions than the studs 408). In another example, the termination structure 508 may be formed from a material having different properties from the studs 408, such as from a stronger material. For example, the termination structures 508 may be formed from a metal material, where the studs 408 are formed from wood. In another example, the termination structure 508 may be formed from a larger wooden structure and the studs 408 may be formed from sheet metal.

The termination structures 508 of adjacent segments 506 in the wall 400 may be joined together. Thus, adjacent segments 506 may combine to form a wall 400 that is longer than the individual segments 506. In some embodiments, the segments 506 are joined together at a corner structure 504, such that the segments 506 extend at an angle relative to one another to form a corner of the associated structure 500.

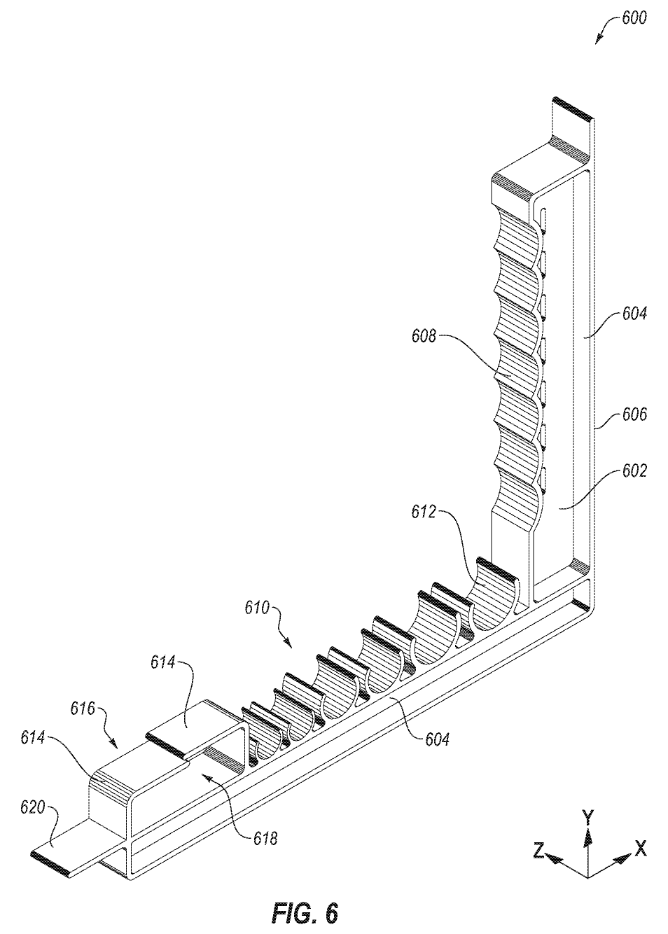

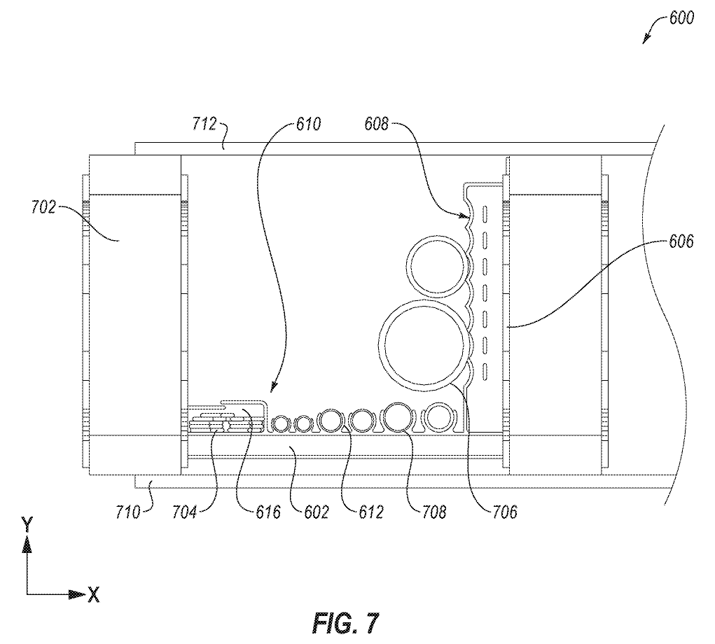

FIGS. 6 and 7 show another embodiment of a spacer 600. The spacer 600 is defined by a frame 602. The spacer 600 illustrated in FIGS. 6 and 7, has a frame 602 including two arms 604 extending in a same plane in two directions. A substantially perpendicular angle (e.g., 90 degree angle) is formed between the two arms 604, such that the frame 602 exhibits an “L” shape. The spacer 600 includes an outer wall 606 around the perimeter of the frame 602. The outer wall 606 of the spacer 600 may be configured to rest against or be secured to structures of an associated wall, such as studs 702, outer structures 710, inner structures 712, alignment structures, etc.

The spacer 600 may include multiple recesses 608 and/or clamping structures 610. The recess 608 and clamping structures 610 may be configured to receive utilities therein and secure them relative to the spacer 600. The clamping structures 610 may include circular clamping structures 612 and/or elongated clamping structures 616, similar to the circular clamps 214 (FIG. 2) and elongated clamps 216 (FIG. 2) described above. In the embodiment illustrated in FIGS. 6 and 7, the spacer 600 includes smaller circular clamping structures 612, an elongated clamping structure 616, and additional recesses 608 configured to receive utilities that are larger than the smaller circular clamping structures 612 and the elongated clamping structure 616 are configured to receive. As illustrated in FIG. 7, the circular clamping structures 612 secure water lines 708 to the frame 602 of the spacer 600, the elongated clamping structure 616 secures wires 704 to the frame 602 of the spacer 600, and the recesses 608 are securing larger pipes 706 relative to the frame 602 of the spacer 600.

In some embodiments, the elongated clamping structure 616 is configured similar to the elongated clamp 216 illustrated in FIG. 2, with an arm having a floating end configured to receive utilities therein. In the embodiment illustrated in FIGS. 6 and 7, the elongated clamping structure 616 includes two clamping arms 614 separated near the middle of the elongated clamping structure 616. The clamping arms 614 define an opening 618 in the elongated clamping structure 616 configured to receive one or more utilities therein. The two separated clamping arms 614 may facilitate the utilities to pass through the separation and be positioned within the opening 618 in the elongated clamping structure 616. In some embodiments, the clamping arms 614 are configured to be deformed (e.g., clamped) into the opening 618 to secure the associated utility in the elongated clamping structure 616.

The spacer 600 may include one or more locator pins 620. The locator pin 620 may extend away from the frame 602 in a direction substantially parallel with the directions of the arms 604. Thus, the locator pins 620 may extend in at least one of the X-direction and the Y-direction. The locator pins 620 may be configured to extend at least partially into the adjacent studs 702. Thus, the locator pin 620 may facilitate fixing the spacer 600 relative to the studs 702.

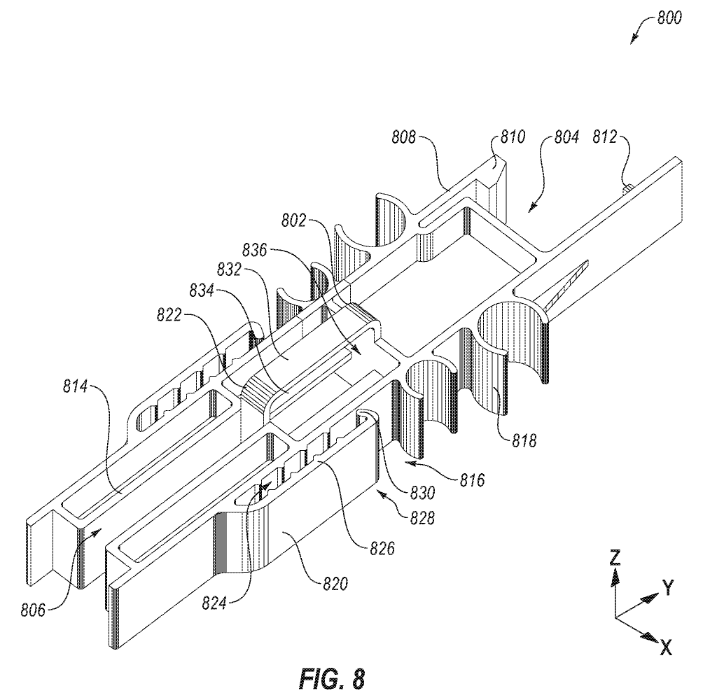

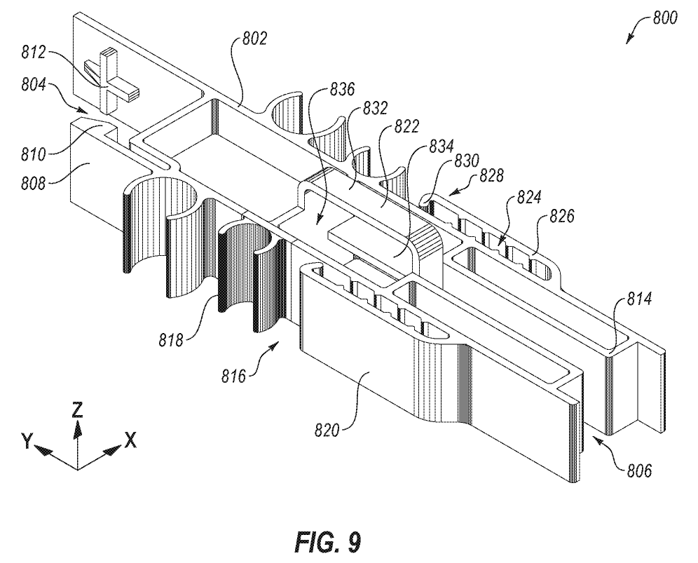

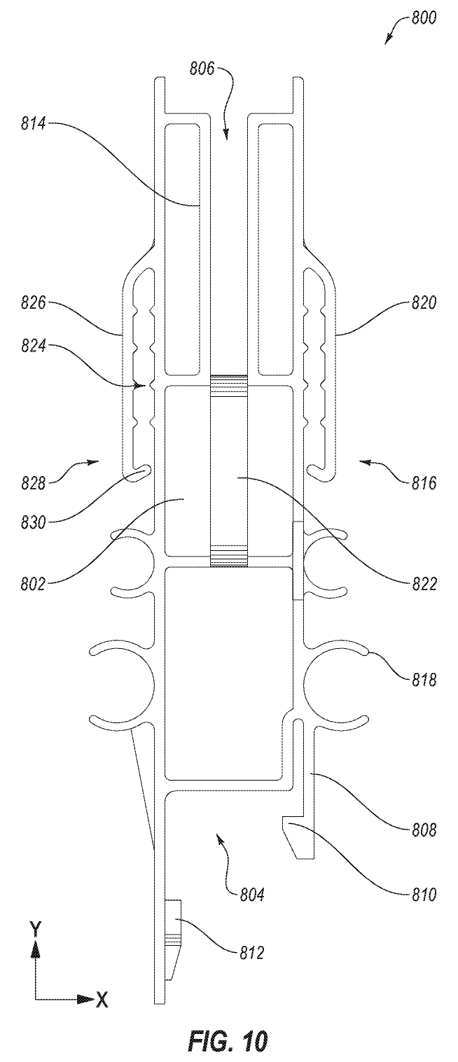

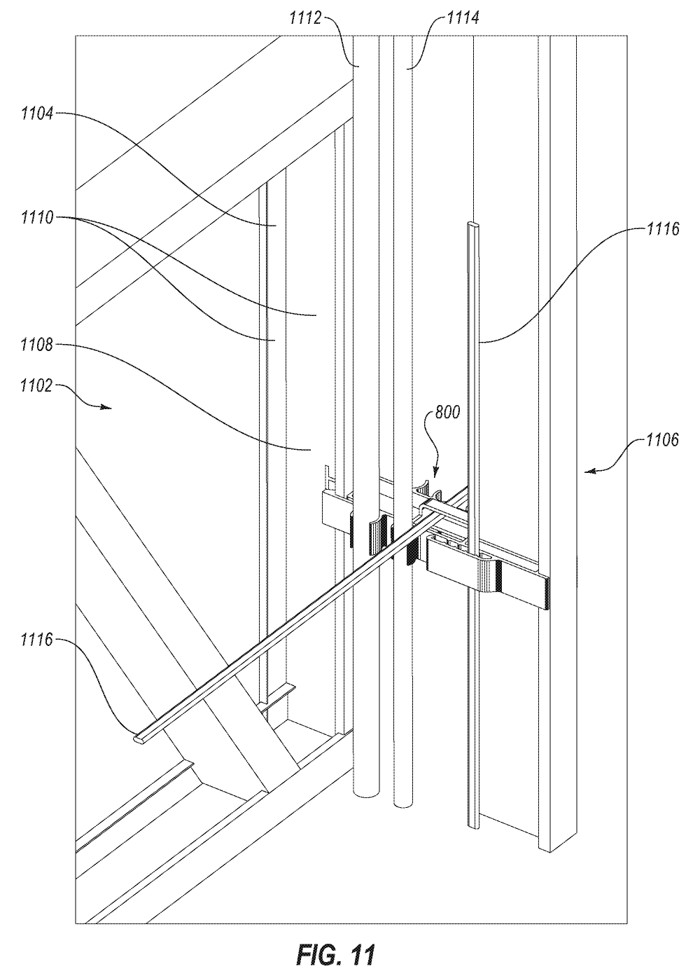

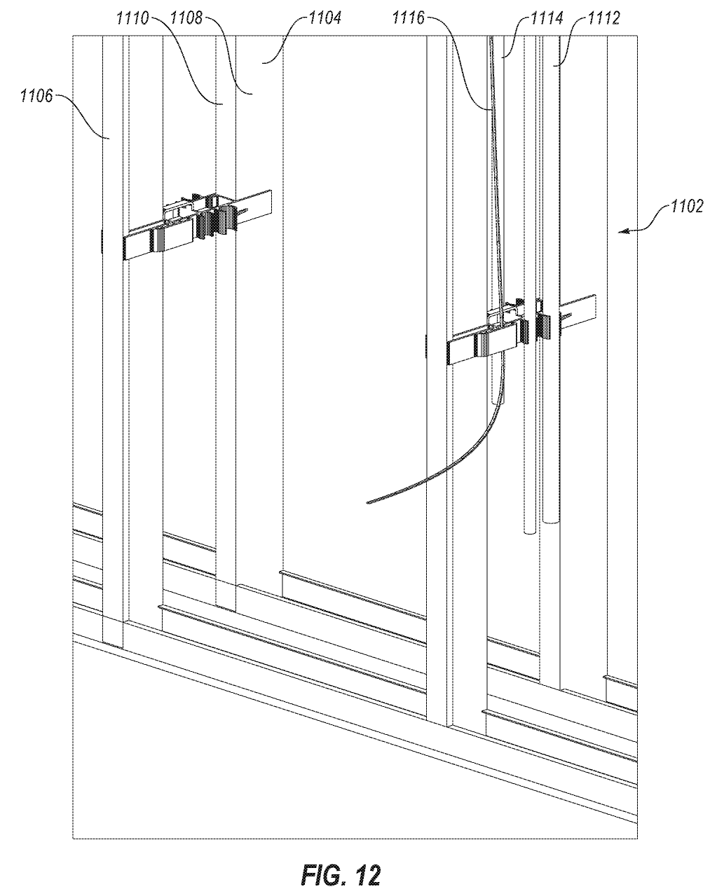

FIGS. 8-12 illustrate another embodiment of a spacer 800. The spacer 800 includes a frame 802 defining a primary gap 804 and a secondary gap 806. As discussed above, the primary gap 804 is configured to receive a stud 1104 and the secondary gap 806 is configured to receive an alignment structure 1106 as illustrated in FIGS. 11 and 12. FIGS. 11 and 12 illustrate the spacer 800 connected to a framework 1102 of metal studs 1104 and an alignment structure 1106 formed from material having smaller dimensions than the studs 1104.

The primary gap 804 may include a stud clip 808. The stud clip 808 may be configured to secure the spacer 800 to a metal stud 1104. For example, in the embodiment illustrated in FIGS. 8-12, the stud clip 808 includes a retaining structure 810 configured to capture a flange 1110 of the metal stud 1104 and a locator structure 812 configured to interface with a web 1108 of the metal stud 1104. A metal stud 1104 may be formed in a C-channel design. Therefore, the retaining structure 810 of the stud clip 808 may be configured to pass over the flange 1110 of the metal stud 1104 and into the C-channel securing the metal stud 1104 to the spacer 800. The metal stud 1104 may also include an opening in the web 1108, such as a knockout, and the locator structure 812 may be a protrusion configured to be disposed in the opening in the web 1108 further securing the metal stud 1104 to the spacer 800.

The secondary gap 806 may include removable portions 814 similar to the other embodiments of a spacer (e.g., spacer 108, 200, 600) described above. The removable portions 814 may define the secondary gap 806 to be smaller than the primary gap 804 and configured to receive alignment structures 1106 formed from material having smaller dimensions than the studs 1104. For example, in the embodiment illustrated in FIG. 11, the alignment structures 1106 are formed from wooden sheet material, such as plywood or chip board. In other embodiments, the alignment structures 1106 may be formed from other sheeting materials, such as wood paneling, drywall, plasterboard, cement sheet, metal plate, etc. The removable portions 814 may be configured to be removed, such as by cutting, bending, or breaking along pre-defined break points to create a larger secondary gap 806. The larger secondary gap 806 may be configured to receive studs 1104 or alignment structures 1106 having similar dimensions to the studs 1104.

The spacer 800 may include clamping structures 816 defined about the frame 802 of the spacer 800. Similar to the other embodiments of the spacer (e.g., spacer 108, 200, 600) described above, the clamping structures 816 may be configured to secure utilities, such as pipes 1112, water lines 1114, and wires 1116 to the spacer 800 in the area between the outer structure and inner structure of the associated wall. The clamping structures 816 may include circular clamping structures 818 having different sizes elongated clamping structures 820, and lateral clamping structures 822.

The circular clamping structures 818 may be configured to secure utilities having circular cross-sections, such as pipes 1112, water lines 1114, and conduits. In the embodiments illustrated in FIGS. 8-12, the spacer 800 includes circular clamping structures 818 having two different sizes. Each side of the spacer 800 include a small circular clamping structure 818 and a larger circular clamping structure 818. In other embodiments, the spacer 800 may include different sizes of circular clamping structures 818 on each side of the spacer 800. For example, a first side of the spacer 800 may include the small circular clamping structure 818 and the large circular clamping structure 818 as illustrated in FIGS. 8-12, and a second side of the spacer 800 may include a circular clamping structure 818 that is larger than the large circular clamping structure 818 on the first side of the spacer 800, such that the spacer 800 includes circular clamping structures 818 having three different sizes.

The elongated clamping structure 820 may be configured to secure smaller utilities or utilities that are more flexible than pipes and conduit, such as wires 1116. In the embodiment illustrated in FIGS. 8-12, the elongated clamping structure 820 includes a clamping arm 826 defining an elongated opening 824 configured to receive the utility. The clamping arm 826 includes a floating end 828 that is not connected to the frame 802 of the spacer 800. The floating end 828 includes a retaining structure 830 configured to capture the utility once the utility passes through the floating end 828 of the clamping arm 826 into the elongated opening 824 of the elongated clamping structure 820. In other embodiments, the elongated clamping structure 820 may be configured similar to the elongated clamping structure 616 illustrated in the embodiment in FIGS. 6 and 7, with two clamping arms separated in a central portion of the elongated clamping structure 820 and configured to be deformed into the elongated opening 824 to secure the utility within the elongated clamping structure 820.

The lateral clamping structure 822 may be configured to secure a utility to the spacer 800 in a direction substantially parallel to the frame 802 (e.g., in the X-direction). For example, the lateral clamping structure 822 may facilitate capturing utilities extending in a direction perpendicular to the utilities captured by the circular clamping structures 818 and the elongated clamping structures 820. In some embodiments, the lateral clamping structures 822 facilitate utilities that are already captured in one of the circular clamping structures 818 or the elongated clamping structures 820 to change direction within the associated wall. In some embodiments, the lateral clamping structure 822 is sized and shaped similar to the elongated clamping structure 820. In other embodiments, the lateral clamping structure 822 may be larger to facilitate the capture of larger utilities, a greater number of utilities, or a wider variety of utilities. The lateral clamping structure 822 may include an outer arm 832, a retaining arm 834, and an opening 836 defined between the retaining arm 834 and the frame 802 of the spacer 800. The opening 836 may facilitate positioning utilities within the lateral clamping structure 822 between the outer arm 832 and the retaining arm 834.

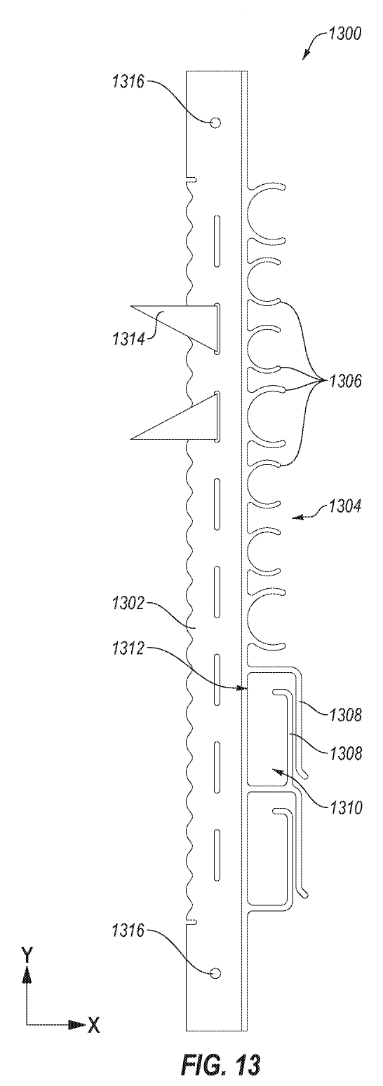

FIGS. 13 through 15 show another embodiment of a spacer 1300. The spacer 1300 is defined by a frame 1302. The frame 1302 of the spacer 1300 extends in one direction. The spacer 1300 includes circular clamping structures 1306 concentrated on a first side of the spacer 1300.

The clamping structures 1304 may be configured to receive utilities therein and secure them relative to the spacer 1300. The clamping structures 1304 may include circular clamping structures 1306 and/or elongated clamping structures 1310, similar to the circular clamps 214 (FIG. 2) and elongated clamps 216 (FIG. 2) described above. In the embodiment illustrated in FIGS. 13 through 15, the spacer 1300 includes smaller circular clamping structures 1306, and elongated clamping structures 1310 extending from the first side of the spacer 1300.

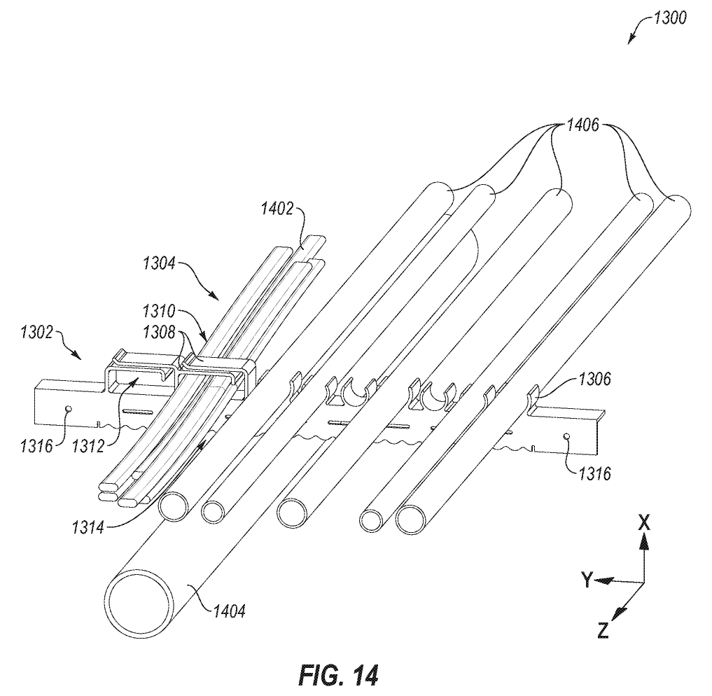

A second side of the spacer 1300 is substantially free of clamping structures 1304 and may be configured to mount against studs 1502 or a framework 1504 of studs 1502 forming a wall. The second side of the spacer 1300 may also include one or more mounting structures 1314 configured to receive utilities that are larger than the smaller circular clamping structures 1306 and the elongated clamping structures 1310 are configured to receive. As illustrated in FIG. 14, the circular clamping structures 1306 secure water lines 1406 to the frame 1302 of the spacer 1300, the elongated clamping structures 1310 secure wires 1402 to the frame 1302 of the spacer 1300, and the mounting structure 1314 secures larger pipes 1404, such as drain pipes 1404 or sewer pipes 1404, to the frame 1302 of the spacer 1300.

In some embodiments, the elongated clamping structure 1310 is configured similar to the elongated clamp 216 illustrated in FIG. 2, with an arm having a floating end configured to receive utilities therein. In the embodiment illustrated in FIGS. 13 through 14, the elongated clamping structure 1310 includes two clamping arms 1308 overlapping one another across the elongated clamping structure 1310. The clamping arms 1308 define an opening 1312 in the elongated clamping structure 1310 configured to receive one or more utilities therein. The two separated clamping arms 1308 may facilitate the utilities to pass between the overlapping clamping arms 1308 to be positioned within the opening 1312 in the elongated clamping structure 1310.

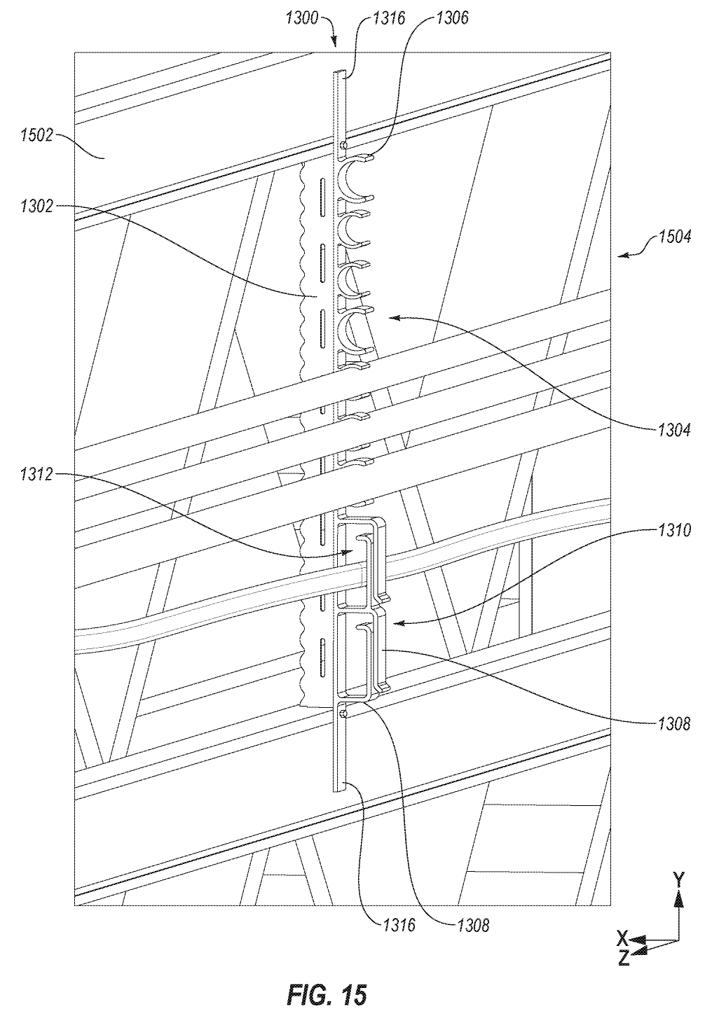

The spacer 1300 may include one or more mounting tabs 1316. The mounting tabs 1316 may extend away from the frame 1302 in a direction substantially parallel with the direction of the frame 1302. The mounting tabs 1316 may be configured to receive hardware and secure the spacer 1300 to adjacent studs 1502 in the associated framework 1504. In some embodiments, the spacer 1300 is configured to define a spacing of the associated studs 1502 in the framework 1504. In some embodiments, the spacer 1300 is configured to be secured to an outer face of the studs 1502 in the framework 1504, as illustrated in FIG. 15, such that the clamping structures 1304 face away from the framework 1504.

The embodiments of the disclosure may facilitate uniform construction of a wall. Uniform construction of a wall may reduce damage to utilities within the wall. Furthermore, uniform construction may reduce the time to construct the wall. Thus, uniform construction of the wall may increase the efficiency of building an associated structure by both reducing losses due to damage of utilities in the wall and by reducing the time to construct the wall. Increasing the efficiency of building a structure may reduce the costs of building the structure.

The embodiments of the disclosure described above and illustrated in the accompanying drawing figures do not limit the scope of the invention, since these embodiments are merely examples of embodiments of the invention, which is defined by the appended claims and their legal equivalents. Any equivalent embodiments are intended to be within the scope of this disclosure. Indeed, various modifications of the disclosure, in addition to those shown and described herein, such as alternative useful combinations of the elements described, may become apparent to those skilled in the art from the description. Such modifications and embodiments are also intended to fall within the scope of the appended claims and their legal equivalents.

What is claimed is:

1. A wall spacer comprising:
a frame;
a clamping structure extending from the frame, the clamping structure configured to secure one or more utilities to the frame;
a primary gap defined in a first end of the frame, the primary gap configured to receive a first structural component; and
a secondary gap defined in a second end of the frame opposite the first end of the frame, the secondary gap configured to receive a second structural component.

2. The wall spacer of claim 1, wherein the frame includes a stud clip defining the primary gap, the stud clip configured to secure the frame to a stud.

3. The wall spacer of claim 2, wherein the stud clip comprises a retaining structure configured to capture a flange of a C-channel metal stud.

4. The wall spacer of claim 1, wherein the frame includes removable portions defining the secondary gap.

5. The wall spacer of claim 4, wherein the removable portions define the secondary gap to be narrower than the primary gap.

6. The wall spacer of claim 4, wherein the secondary gap is configured to be a same size as the primary gap with the removable portions removed.

7. The wall spacer of claim 1, wherein the clamping structure comprises one or more circular clamping structures.

8. The wall spacer of claim 1, wherein the clamping structure comprises one or more elongated clamping structures.

9. The wall spacer of claim 1, wherein the clamping structure comprises one or more lateral clamping structures.

10. A wall comprising:
a framework formed from one or more studs;
an alignment structure; and
one or more spacers positioned between the framework and the alignment structure, at least one of the one or more studs disposed in a primary gap of the one or more spacers and the alignment structure disposed in a secondary gap of the one or more spacers, wherein the primary gap and the secondary gap are on opposing sides of the one or more spacers.

11. The wall of claim 10, further comprising one or more utilities secured to the one or more spacers through clamping structures.

12. The wall of claim 11, wherein the one or more utilities include at least one of water lines, pipes, and electrical wires.

13. The wall of claim 10, wherein the alignment structure comprises a “T” shaped alignment structure including a web and a flange formed from sheeting materials.

14. The wall of claim 10, wherein the primary gap is defined in a single spacer of the one or more spacers.

15. The wall of claim 10, wherein the primary gap is defined between two spacers of the one or more spacers.

16. The wall of claim 15, further comprising a connecting structure between the two spacers of the one or more spacers, the connecting structure positioned between the primary gap and the secondary gap.

17. A method of constructing a wall, the method comprising:
forming a framework from studs;
disposing at least one stud of the studs into a primary gap defined by a spacer; and
disposing an alignment structure into a secondary gap defined by the spacer on an opposite side of the spacer from the framework.

18. The method of claim 17, further comprising securing one or more utilities to the spacer through one or more clamping structures.

19. The method of claim 17, wherein disposing the at least one stud of the studs into the primary gap comprises disposing the at least one stud of the studs into the primary gap defined by a stud clip of the spacer.

20. The method of claim 17, wherein disposing the at least one stud of the studs into the primary gap comprises disposing the at least one stud of the studs into the primary gap, where the primary gap is defined between two spacers.
